(19) United States
(12) Patent Application Publication
(10) Pub. No.: US 2025/0141519 A1
(43) Pub. Date: May 1, 2025

(54) TRAINING METHOD, METHOD FOR USING MODEL, WIRELESS COMMUNICATION METHOD, AND APPARATUS

(71) Applicant: GUANGDONG OPPO MOBILE TELECOMMUNICATIONS CORP., LTD., Dongguan (CN)

(72) Inventors: Dexin LI, Dongguan (CN); Wenqiang TIAN, Dongguan (CN)

(21) Appl. No.: 19/004,264

(22) Filed: Dec. 28, 2024

Related U.S. Application Data
(63) Continuation of application No. PCT/CN2022/109126, filed on Jul. 29, 2022.

(51) Int. Cl. H04B 7/06; G06N 20/00

(52) U.S. Cl. CPC H04B 7/0626; G06N 20/00

(57) ABSTRACT

Disclosed are a training method, a method for using a model, a wireless communication method, and an apparatus. The training method includes: generating, by a first device, a second data set according to a first data set, where data in the second data set is low-dimensional representation data of data in the first data set; and training, by the first device according to the second data set, a first model used for wireless communication.

This application is a continuation of International Application No. PCT/CN2022/109126, filed on Jul. 29, 2022, the disclosure of which is hereby incorporated by reference in its entirety.

### TECHNICAL FIELD

This application relates to the field of communications technologies, and more specifically, to a training method, a method for using a model, a wireless communication method, and an apparatus.

### BACKGROUND

With development of artificial intelligence (AI) technologies, wireless communication also starts to be performed by using a model in a wireless communications system, to improve communication performance. However, when a model is trained by using a data set, a problem of relatively poor training timeliness exists.

### SUMMARY

This application provides a training method, a method for using a model, a wireless communication method, and an apparatus. The following describes the aspects involved in this application.

According to a first aspect, a training method is provided, including: generating, by a first device, a second data set according to a first data set, where data in the second data set is low-dimensional representation data of data in the first data set; and training, by the first device according to the second data set, a first model used for wireless communication.

According to a second aspect, a method for using a model is provided, including: generating, by a first device, second data according to first data, where the second data is low-dimensional representation data of the first data; and obtaining, by the first device according to the second data and a first model used for wireless communication, a processing result of the first model.

According to a third aspect, a wireless communication method is provided, including: receiving, by a terminal device, a first model and a second model from a network device, where the second model is used to convert first data of the terminal device into second data, the second data has less dimensions than the first data, and the first model is used to process the second data.

According to a fourth aspect, a wireless communication method is provided, including: transmitting, by a network device, a first model and a second model to a terminal device, where the second model is used to convert first data of the terminal device into second data, the second data has less dimensions than the first data, and the first model is used to process the second data.

According to a fifth aspect, a training apparatus is provided, including: a generating unit, configured to generate a second data set according to a first data set, where data in the second data set is low-dimensional representation data of data in the first data set; and a training unit, configured to train, according to the second data set, a first model used for wireless communication.

According to a sixth aspect, an apparatus for using a model is provided, including: a generating unit, configured to generate second data according to first data, where the second data is low-dimensional representation data of the first data; and a processing unit, configured to obtain, according to the second data and a first model used for wireless communication, a processing result of the first model.

According to a seventh aspect, a terminal device is provided, including: a receiving unit, configured to receive a first model and a second model from a network device, where the second model is used to convert first data of the terminal device into second data, the second data has less dimensions than the first data, and the first model is used to process the second data.

According to an eighth aspect, a network device is provided, including: a transmitting unit, configured to transmit a first model and a second model to a terminal device, where the second model is used to convert first data of the terminal device into second data, the second data has less dimensions than the first data, and the first model is used to process the second data.

According to a ninth aspect, a device is provided, including a memory and a processor, where the memory is configured to store a program, and the processor is configured to invoke the program in the memory to execute the method according to any one of the first aspect to the fourth aspect.

According to a tenth aspect, an apparatus is provided, including a processor configured to invoke a program from a memory to execute the method according to any one of the first aspect to the fourth aspect.

According to an eleventh aspect, a chip is provided, including a processor configured to invoke a program from a memory to cause a device on which the chip is installed to execute the method according to any one of the first aspect to the fourth aspect.

According to a twelfth aspect, a computer-readable storage medium is provided, where a program is stored on the computer-readable storage medium, and the program causes a computer to execute the method according to any one of the first aspect to the fourth aspect.

According to a thirteenth aspect, a computer program product is provided, including a program, where the program causes a computer to execute the method according to any one of the first aspect to the fourth aspect.

According to a fourteenth aspect, a computer program is provided, where the computer program causes a computer to execute the method according to any one of the first aspect to the fourth aspect.

### BRIEF DESCRIPTION OF DRAWINGS

FIG. 1 shows a wireless communications system to which embodiments of this application are applied.

FIG. 2 is a structural diagram of a neural network to which embodiments of this application are applicable.

FIG. 3 is a structural diagram of a CNN to which embodiments of this application are applicable.

FIG. 4 is a schematic diagram of a CSI feedback system according to an embodiment of this application.

FIG. 5 is a schematic structural diagram of an auto-encoder.

FIG. 6 is a schematic diagram of an online training manner.

FIG. 7 is a schematic diagram of an offline training manner.

FIG. 8 is a schematic flowchart of a training method according to an embodiment of this application.

FIG. 9 is a schematic diagram of a VAE encoder according to an embodiment of this application.

FIG. 10 is a schematic diagram of a second model according to an embodiment of this application.

FIG. 11 is a schematic diagram of a manner of training a first model according to an embodiment of this application.

FIG. 12 is a schematic flowchart of a method for using a model according to an embodiment of this application.

FIG. 13 is a schematic flowchart of a wireless communication method according to an embodiment of this application.

FIG. 14 is a schematic flowchart of a method for performing offline training by a network device according to an embodiment of this application.

FIG. 15 is a schematic diagram of an online training manner according to an embodiment of this application.

FIG. 16 is a schematic flowchart of a method for executing online training by a network device according to an embodiment of this application.

FIG. 17 is a schematic flowchart of a method for executing online training by a terminal device according to an embodiment of this application.

FIG. 18 is a schematic block diagram of a training apparatus according to an embodiment of this application.

FIG. 19 is a schematic block diagram of an apparatus for using a model according to an embodiment of this application.

FIG. 20 is a schematic block diagram of a terminal device according to an embodiment of this application.

FIG. 21 is a schematic block diagram of a network device according to an embodiment of this application.

FIG. 22 is a schematic structural diagram of an apparatus according to an embodiment of this application.

### DESCRIPTION OF EMBODIMENTS

The following describes the technical solutions in this application with reference to the accompanying drawings.

FIG. 1 shows a wireless communications system 100 to which embodiments of this application are applied. The wireless communications system 100 may include a network device 110 and terminal devices 120. The network device 110 may be a device that communicates with the terminal devices 120. The network device 110 may provide communication coverage for a specific geographic area, and may communicate with the terminal devices 120 located within the coverage area.

FIG. 1 exemplarily shows one network device and two terminals. Optionally, the wireless communications system 100 may include a plurality of network devices, and another quantity of terminal devices may be included within a coverage range of each network device. This is not limited in embodiments of this application.

Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal device in embodiments of this application may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may refer to a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, a UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without needing to relay a communication signal by using a base station.

The network device in embodiments of this application may be a device configured to communicate with the terminal device. The network device may also be referred to as an access network device or a radio access network device. For example, the network device may be a base station. The network device in embodiments of this application may refer to a radio access network (RAN) node (or device) that connects the terminal device to a wireless network. The base station may broadly cover various names in the following, or may be replaced with the following names, for example: a NodeB, an evolved NodeB (eNB), a next-generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may refer to a communications module, a modem, or a chip disposed in the device or apparatus described above. Alternatively, the base station may be a mobile switching center, a device that functions as a base station in device-to-device D2D, vehicle-to-everything (V2X), and machine-to-machine (M2M) communications, a network-side device in a 6G network, a device that functions as a base station in a future communications system, or the like. The base station may support networks of a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device that communicates with another base station.

In some deployments, the network device in embodiments of this application may refer to a CU or a DU, or the network device includes a CU and a DU. A gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of a communications device in this application may also be implemented by software functions running on hardware, or by virtualization functions instantiated on a platform (for example, a cloud platform).

AI is a theory, method, technology, and application system that simulates, extends, and expands human intelligence by using a digital computer or a machine controlled by a digital computer, to perceive an environment, obtain knowledge, and use the knowledge in order to obtain an optimal result. AI is a popular science and a leading technology of world development, and may be applied to various scenarios in life.

An implementation of AI may be using a neural network. The following describes the neural network.

In recent years, artificial intelligence researches represented by neural networks have made great achievements in many fields, and will also play an important role in people's production and life for a long time to come. In particular, as an important research direction of the AI technology, machine learning (ML) successfully resolves, by using a non-linear processing capability of a neural network (NN), a series of problems that were difficult to handle with, and even exhibits performance stronger than human beings in fields such as image recognition, voice processing, natural language processing, and gaming. Therefore, machine learning has drawn increasing attention recently. Common neural networks include a convolutional neural network (CNN), a recurrent neural network (RNN), a deep neural network (DNN), and the like.

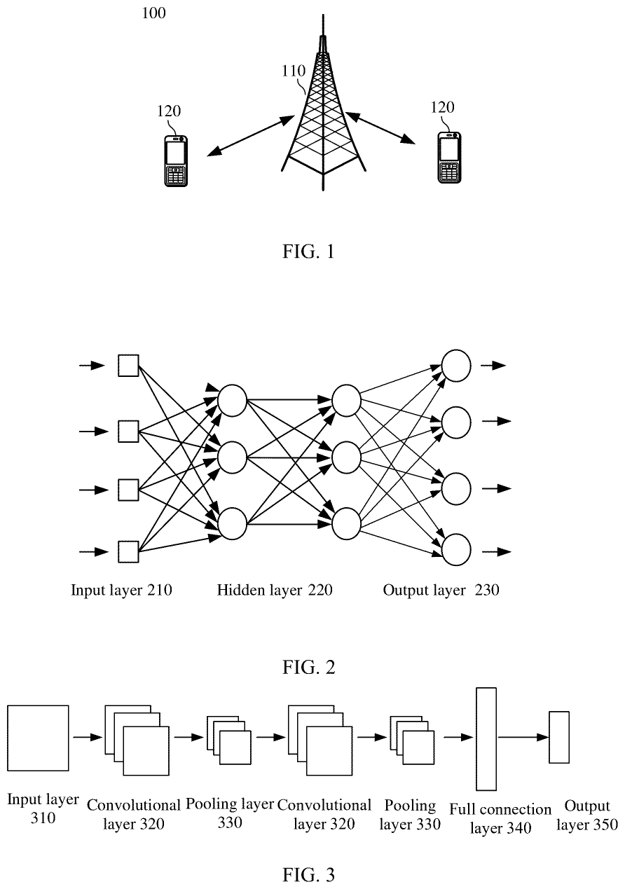

With reference to FIG. 2, the following describes a neural network to which embodiments of this application are applicable. The neural networks shown in FIG. 2 may be divided into three types of layers according to locations of different layers: an input layer 210, a hidden layer 220, and an output layer 230. Generally, the first layer is the input layer 210, the last layer is the output layer 230, and the middle layer between the first layer and the last layer is the hidden layer 220.

The input layer 210 is configured to input data. The hidden layer 220 is configured to process the input data. The output layer 230 is configured to output processed output data.

As shown in FIG. 2, the neural network includes a plurality of layers, and each layer includes a plurality of neurons. Neurons in different layers may be fully connected, or may be partially connected. For connected neurons, an output of neurons of an upper layer may be used as an input of neurons of a lower layer.

With continuous development of neural network researches, neural network deep learning algorithms are also proposed in recent years. A large quantity of hidden layers are introduced into a neural network to form a DNN, which enable the DNN to describe a complex situation in the real world. In theory, a model with a larger quantity of parameters has higher complexity and a larger “capacity”, which means that the model can complete more complex learning tasks. This type of neural network model is widely used in pattern recognition, signal processing, optimization combination, anomaly detection, and the like.

A CNN is a deep neural network with a convolutional structure. As shown in FIG. 3, the structure of the CNN may include an input layer 310, convolutional layers 320, pooling layers 330, a full connection layer 340, and an output layer 350.

Each convolutional layer 320 may include a plurality of convolutional operators, and a convolutional operator is also referred to as a kernel. A function of the convolutional operator may be considered as a filter for extracting specific information from an input signal. The convolutional operator may essentially be a weight matrix, and the weight matrix is generally pre-defined.

Weight values in these weight matrices need to be obtained through a large amount of training in actual application. Each weight matrix formed by the weight values obtained through the training may extract information from an input signal, to help the CNN perform correct prediction.

When the CNN has a plurality of convolutional layers, an initial convolutional layer usually extracts more general features, and the general features may also be referred to as low-level features. As a depth of the CNN increases, features extracted by subsequent convolutional layers are increasingly complex.

Regarding the pooling layers 330, because a quantity of trained parameters often needs to be reduced, a pooling layer often needs to be periodically introduced behind the convolutional layer. For example, as shown in FIG. 3, one pooling layer may follow one convolutional layer, or one or more pooling layers may follow a plurality of convolutional layers. In a signal processing process, the only purpose of the pooling layers is to reduce a size of space of extracted information.

Regarding the full connection layer 340, the CNN still cannot output required output information after the processing at the convolutional layers 320 and the pooling layers 330, because as mentioned above, the convolutional layers 320 and the pooling layers 330 only extract features and reduce a quantity of parameters brought by the input data. To generate the final output information, the CNN needs to utilize the full connection layer 340. Generally, the full connection layer 340 may include a plurality of hidden layers, and parameters included in the plurality of hidden layers may be obtained by performing pre-training using related training data of a specific task type.

Behind the plurality of hidden layers in the full connection layer 340, that is, the last layer of the entire CNN is the output layer 350, which is configured to output a result. Generally, a loss function (for example, a loss function similar to a categorical cross-entropy) is set for the output layer 350, to calculate a prediction error, or in other words, to evaluate a degree of difference between the result (also referred to as a predicted value) output by the CNN model and an ideal result (also referred to as a real value).

To minimize the loss function, the CNN model needs to be trained. In some implementations, the CNN model may be trained by using a backpropagation algorithm (BP). A training process of the BP includes a forward propagation process and a backward propagation process. In the process of forward propagation (as shown in FIG. 3, propagation from 310 to 350 is forward propagation), the input data is input into the foregoing layers of the CNN model, processed layer by layer, and transmitted to the output layer. If a difference between the result that is output at the output layer and the ideal result is relatively large, minimizing the foregoing loss function is used as an optimization objective, and the training process is switched to backward propagation (as shown in FIG. 3, propagation from 350 to 310 is backward propagation). A partial derivative of the optimization objective with respect to each neuron weight value is obtained layer by layer, to constitute a gradient of the optimization objective with respect to a weight value vector, which is used as a basis for modifying a model weight. Then, a training process of the CNN is completed in a weight modification process. When the foregoing difference reaches an expected value, the training process of the CNN ends.

It should be noted that the CNN shown in FIG. 3 is merely an example of a convolutional neural network. In specific applications, the convolutional neural network may further exist in a form of another network model, which is not limited in embodiments of this application.

Since the AI technology, especially deep learning, has achieved great success in computer vision, natural language processing, and the like, a technical problem in the communications field that is difficult to resolve by using a conventional communication method is attempted to be resolved by using a model. Previous research shows that AI has important application potential in many aspects such as modeling of complex and unknown environments, learning, channel prediction, intelligent signal generation and processing, network status tracking and intelligent scheduling, and network optimal deployment. AI is expected to promote evolution of communication standards and changes of network architectures in the future, which is of great significance and value to technological research of a communications system (6G system).

In some embodiments, a communications device may process data by using a first model, thereby improving communication performance and reducing data processing complexity. For example, the communications device may encode and decode the data by using the first model, to improve encoding and decoding performance of the data. The first model may be referred to as an AI model.

Channel state information (CSI) feedback is used as an example. A terminal device may use the first model to perform feature extraction on actual channel information, to generate a bit stream, and a network device may reconstruct the bit stream by using the first model, to restore the actual channel information as much as possible. Using the first model may reduce overheads for performing CSI feedback by the terminal device while ensuring that the actual channel information is restored.

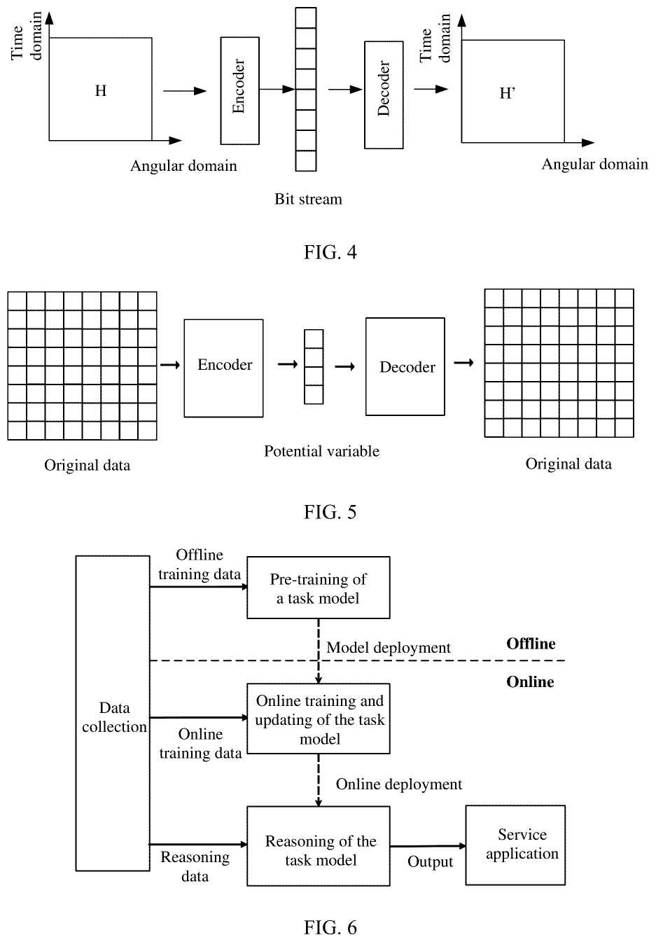

With reference to FIG. 4, the following describes a CSI feedback system.

A network device may transmit a reference signal to a terminal device. The terminal device may perform estimation on a channel based on the reference signal, to obtain CSI data to be fed back. The terminal device encodes, by using an encoder, the CSI data to be fed back, to obtain an encoded bit stream, and transmits the bit stream to the network device. After receiving the bit stream, the network device may decode the bit stream by using a decoder, to restore the original CSI data. The foregoing encoder and decoder may be implemented by using a first model. The first model used to perform CSI feedback is also referred to as a CSI feedback model. The CSI feedback model may include an AI encoder and an AI decoder. A network model structure of the AI encoder and the AI decoder may be flexibly designed, which is not specifically limited in embodiments of this application.

That the first model is a deep learning model is used as an example. A neural network architecture commonly used in deep learning is non-linear and data-driven. The terminal device may use the deep learning model to perform feature extraction on actual channel data, and the network device may use the deep learning model to restore the actual channel data as much as possible. In CSI feedback based on deep learning, channel information is considered as a to-be-compressed image, the channel information is compressed and fed back by using the deep learning model, and the compressed channel image is reconstructed at a receiving end. This may retain the channel information to a greater extent.

An architecture of the CSI feedback system shown in FIG. 4 is the same as an architecture of an auto-encoder (AE). The auto-encoder is a type of neural network used in semi-supervised learning and unsupervised learning, and has a function of performing representation learning on input information by using the input information as a learning objective. FIG. 5 is a schematic structural diagram of an auto-encoder. As shown in FIG. 5, the auto-encoder may include an AI encoder and an AI decoder. After training of the auto-encoder is completed, the AI encoder may be deployed at a transmitting end (for example, a terminal device), and the AI decoder may be deployed at a receiving end (for example, a network device). The transmitting end may encode data by using the AI encoder, and the receiving end may decode data by using the AI decoder.

Currently, in the wireless AI field, training of a first model is extremely important, and a training process of the first model requires a large quantity of computing resources. In most training processes, the first model is used as a black box, and original data is directly used as an input for training and updating.

Performance of the first model is strongly correlated with data distribution. Data distribution is affected by a wireless environment. For example, data distribution is affected by factors such as a time, an environment, and a system policy. This results in a difference between actual data and simulation data in a wireless communications system. If the first model is trained by using the simulation data, performance of the trained first model is extremely poor. Therefore, after the first model is deployed, it is necessary to perform online training. A current training process of the first model may be as shown in FIG. 6. The first model in embodiments of this application may also be referred to as a task model, a service model, or the like.

First, pre-training is performed on the first model by using offline training data. After the pre-training is completed, the first model may be deployed. For example, the first model may be deployed on a terminal device or a network device. If the pre-training of the first model is performed locally, the step of the deployment may be omitted. For example, if the offline training is executed by a network device, the network device may transmit the first model to a terminal device after the offline training is completed. For another example, if the offline training is executed by a third-party device, the third-party device may transmit the first model to a terminal device and/or a network device after the offline training is completed.

Second, after the first model is deployed, online training and updating may be performed on the first model by using online training data. If the online training of the first model is not performed locally, online deployment of the first model needs to be performed after the online training of the first model is completed. For example, if the online training is executed by a network device, after completing the online training of the first model, the network device may transmit the trained first model to a terminal device.

Finally, after training of the first model is completed, reasoning (or referred to as use) of the first model may be executed. The terminal device or the network device may perform reasoning on data by using the first model.

However, in a scenario in which an input of the first model is original data, if a dimension of the original data is relatively large, the first model may have a relatively large quantity of parameters. Therefore, the first model is relatively large, and requires more computing resources to complete a training task. In a case in which a computing capability is limited, it takes a long time to complete the training of the first model, which makes it difficult to meet a timeliness requirement of training the first model. In addition, a training process of a relatively large first model also—relies on more new data, which further increases training time of the first model, especially for online training. Online training has a high requirement on timeliness, and a current training manner cannot meet the timeliness requirement of online training.

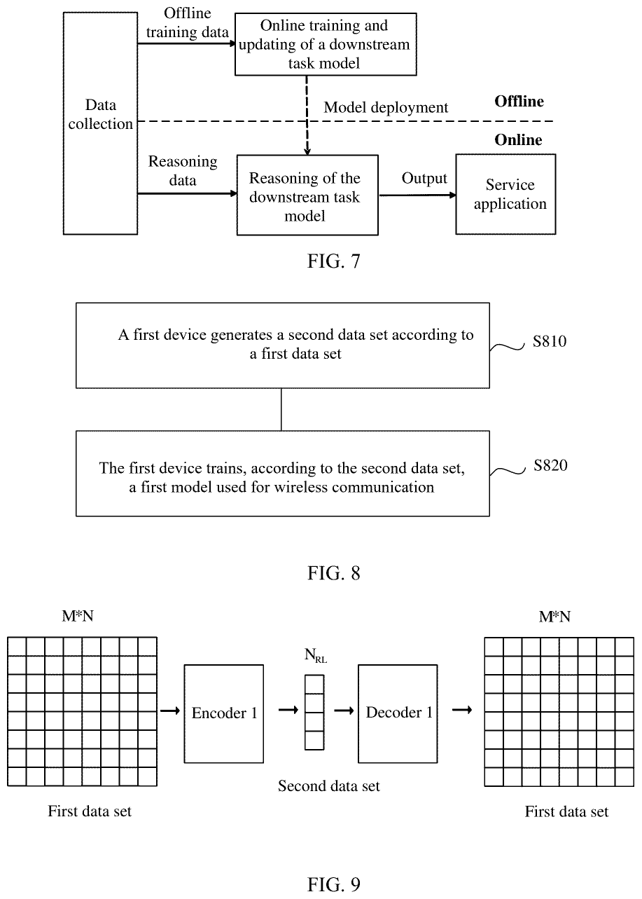

When the first model is relatively large, a conventional training manner as shown in FIG. 7 is generally used, that is, an online training process is omitted, and only offline training is performed on the first model. However, offline training alone cannot effectively counteract an impact of data drift, and the first model on which offline training is performed cannot adapt to a current network environment, and therefore has poor performance.

On the other hand, regardless of the online training or the offline training, the large scale of the first model always results in problems such as a long training time, a long updating period, and a failure to meet the timeliness requirement.

There are two manners of improving a training speed of the first model. The first manner is to reduce an amount of computation in each iteration, and the second manner is to reduce a quantity of training iterations. In the first manner, a lightweight first model needs to be designed, to reduce the amount of computation and improving the training speed. Current researches mainly focus on reducing a quantity of training and iterations, for example, meta-learning. However, for a device (for example, a terminal device) with a limited memory space and a limited computing capability, only reducing a quantity of iterations cannot effectively resolve the problem of timeliness of training the first model.

Based on this, an embodiment of this application provides a training method. According to the method in this embodiment of this application, first, a low-dimensional representation data set of a first data set may be generated, and then a first model is trained based on the low-dimensional representation data set. Because a dimension of input data of the first model is reduced, the method in this embodiment of this application can reduce a quantity of parameters of the first model and a size of the first model. Therefore, training time of the first model can be reduced, thereby meeting a timeliness requirement. With reference to FIG. 8, the following describes a training process in this embodiment of this application.

Referring to FIG. 8, in step S810, a first device generates a second data set according to a first data set.

A type of the first device is not specifically limited in embodiments of this application. The first device may be any type of computing device. For example, the first device may be a communications device, for example, a terminal device or a network device. For another example, the first device may be a non-communications device, that is, the first device may be a dedicated computing device.

The first data set may also be referred to as a training data set. The first data set may be an offline data set, or may be an online data set. The offline data set may include historical real data and/or data generated through simulation. The online data set may be data generated in real time in a wireless communications system. Taking CSI feedback as an example, the first data set may include CSI data to be fed back. A quantity of samples included in the first data set is not specifically limited in embodiments of this application. For example, the first data set may include a single sample, or may include a batch of samples.

Data in the second data set is low-dimensional representation data of data in the first data set. In other words, the data in the second data set has less dimensions than the data in the first data set. A specific manner of generating the second data set will be described in detail below.

In step S820, the first device trains, according to the second data set, a first model used for wireless communication.

The first model in this embodiment of this application may be any AI model in a wireless communications system. The first model may be, for example, a service model or a task model. A type of the first model is not specifically limited in embodiments of this application. For example, the first model may be a neural network model, or the first model may be a deep learning model. In some embodiments, the first model may include a codec model, that is, the first model may include an AI encoder and an AI decoder. For example, the first model may include a CSI feedback model, or the first model may include a channel prediction model (or referred to as a channel estimation model). Certainly, in some embodiments, the first model may also include an encoding model, that is, the first model includes an AI encoder. Alternatively, the first model may include a decoding model, that is, the first model includes an AI decoder.

That the first device trains the first model according to the second data set may be understood as: the first device trains the first model by using the data in the second data set as an input of the first model. In some embodiments, the first device may use the data in the second data set as the input of the first model, to obtain an output result of the first model; and the first device trains the first model by using a difference between the output result of the first model and label data of the first model. The label data may be set according to an actual requirement, which is not specifically limited in embodiments of this application. For example, the first model includes a codec model, and the label data may be data in the first data set.

For example, it is assumed that the first model is a CSI feedback model. Then, the label data may be the first data set, that is, the label data may be a feature vector of a channel. It is assumed that the first model is a channel prediction model. Then, the label data may be channel information at a future moment.

Compared with the data in the first data set, the data in the second data set has less dimensions. Therefore, the first model is trained by using the data in the second data set. This can reduce a quantity of parameters in the first model and reduce a size of the first model, thereby improving timeliness of training the first model.

The training method in this embodiment of this application may be applied to online training and offline training. It may be learned from the foregoing that a current first model can be trained only in an offline manner due to the problem of poor timeliness of online training. The solution in this embodiment of this application can improve timeliness of training the first model. Therefore, the solution in this embodiment of this application facilitates evolution of the first model from offline training to online training. That is, the solution in this embodiment of this application may be used to perform online training on the first model. Performing online training on the first model further helps counteract an impact of data distribution drift. For example, after the first model is deployed, online training and updating may be performed on the first model by using data generated in real time. Therefore, the first model can match a current network environment, thereby improving performance of the first model.

In a case of online training, an execution time of online training is not specifically limited in embodiments of this application. As an example, online training may be executed when new data is generated. As another example, online training may be executed when a quantity of samples reaches a preset threshold. The preset threshold may be set according to an actual requirement. For example, the preset threshold may be one or more of the following: 16, 32, 64, 128, or 512. As still another example, online training may be executed at a fixed interval, that is, online training may be periodically executed. The fixed interval may be set according to an actual requirement. For example, the fixed interval may be one or more of the following: 5 slots, 10 slots, 20 slots, or the like.

A manner of generating the second data set is not limited in embodiments of this application. For example, the first device may process the data in the first data set by using a second model, to generate the second data set. For another example, the first device may process the data in the first data set by using a specific algorithm, to generate the second data set. The specific algorithm may be referred to as feature engineering. The algorithm may be designed according to some experience and prior knowledge. For example, the specific algorithm may be a dimensionality reduction algorithm and/or a matrix decomposition algorithm, or the like, and a process of obtaining optimal representation data may be considered as a special training manner.

In some embodiments of this application, in a case in which a data volume is relatively small, the second data set may be generated by using a specific algorithm, and in a case in which the data volume is relatively large or data is relatively complex, the second data set may be generated by using a second model. Alternatively, in this embodiment of this application, the second data set may be generated by using the second model regardless of the data volume and complexity of the data, that is, regardless of whether the data volume is large or whether the data is complex.

The second model in this embodiment of this application may include a representation learning model. Representation learning is a type of machine learning method that can learn of a representation of data to extract useful information of the data. The purpose of representation learning is to simplify complex original data, remove invalid or redundant information from the original data, and refine valid information to form a feature. Therefore, dimensionality reduction processing is performed on the data in the first data set by using a representation learning model. This may retain more useful information of the data, thereby facilitating subsequent model training.

A specific implementation of the second model is not specifically limited in embodiments of this application, provided that dimensions of data can be reduced and useful information of the data can be retained. In some embodiments, the second model may include an encoder in a variational auto-encoder (VAE) model. The VAE model has a strong representation capability, that is, a small dimension (or vector) may be used to represent more information, and can include higher-layer feature information. Therefore, using the encoder in the VAE model may reduce dimensions of data to a greater extent, thereby further reducing the size of the first model and improving timeliness of training the first model.

A structure of the VAE is consistent with that of an auto-encoder, both including an encoder and a decoder. Unlike the auto-encoder, however, the VAE may add constraints to the encoder part, that is, an output of the encoder may be customized. For example, an AI encoder may be constrained to output potential variables in Gaussian distribution. In other words, the encoder in the VAE model may output better spatial embedding, rather than uncontrolled distribution space. Therefore, the output of the encoder in the VAE model may be used as a low-dimensional representation of original data. Different data in this new embedding space forms a more correlated distribution, which facilitates learning of a downstream model (for example, the first model).

Because the output of the encoder in the VAE model may be customized, when the encoder in the VAE model is used to generate the second data set, the dimension of the data in the second data set may be customized. That is, in this embodiment of this application, the dimension of the data in the second data set may be flexibly designed according to an actual requirement.

In some embodiments of this application, the second model may be further trained according to the first data set. For example, the first device may train the second model by using the first data set as an input of the second model. After training of the second model is completed, the first device may process the first data set by using the trained second model, to generate the second data set.

The following describes a training process of the second model by using an example in which the second model includes an encoder in a VAE model.

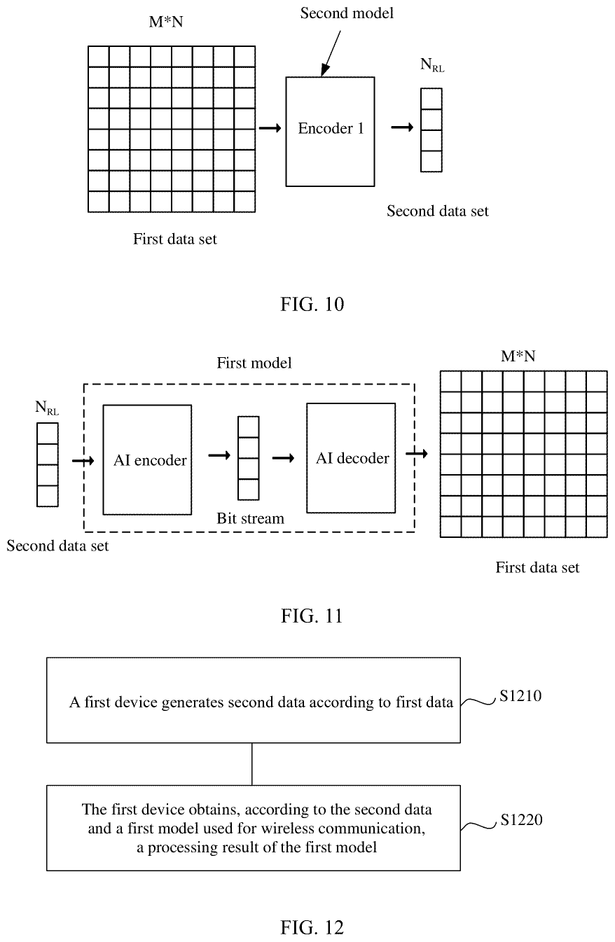

As shown in FIG. 9, the VAE model may include an encoder 1 and a decoder 1. The first device may train the VAE model by using the first data set as an input and an output of the VAE model. A dimension Ni, of output data of the encoder 1 may be set in advance. After training of the VAE model is completed, only the encoder 1 may be retained while the decoder 1 may be deleted. In addition, the encoder 1 may be used as the second model. An input of the encoder 1 may be the first data set, and an output may be the second data set. A dimension of the second data set is N_{RL}. The second model that is finally obtained may be shown in FIG. 10.

A specific manner of training the second model may be determined based on a representation learning algorithm, which is not specifically limited in embodiments of this application. For example, the VAE model is used as an example. The input and the output of the VAE model are the same, and a loss function of a VAE standard, for example, reconstruction loss and distribution assumption loss, may be used to obtain the VAE model through training.

The second model is not sensitive to data distribution, that is, performance of the second model is not greatly affected by different data distribution. Therefore, after the second model is deployed, updating and training may not be performed on the second model, but only performed on the first model.

The following describes the first data set and the second data set with reference to two specific examples. It should be understood that the following examples are merely examples for ease of understanding and are not intended to limit the solutions in embodiments of this application.

Example 1: For a CSI feedback scenario, the first data set may be a feature vector of a channel. For example, a transmitting terminal device has 32 ports and a subcarrier is divided into 13 sub-bands. In this case, the first data set w may include 13 sub-band feature vectors:
w=[w₁, w₂, . . . , w₁₃].

wₖ represents the k^{th} sub-band feature vector, and 1≤k≤13. Each sub-band feature vector wₖ includes complex number information of each transmitting port. During model training, complex number information is generally decomposed into real part information and imaginary part information. For example, a terminal device has 32 transmitting ports. In this case, wₖ may be represented as:
wₖ=[Re{w_{k,1}}, Im{w_{k,1}}, Re{w_{k,2}}, Im{w_{k,2}}, Re{w_{k,32}}, Im{w_{k,32}}].

Re{ } and Im{ } represent a real part and an imaginary part of a complex number, respectively. Therefore, a sample of the first data set is a vector with 13*32*2 real numbers, having a dimension size of 832. As a quantity of ports and a quantity of sub-bands into which a subcarrier is divided increase, a dimension of the first data set is multiplied. In this embodiment of this application, the first model (for example, a representation learning model) may be used to reduce the dimension of the first data set to a target dimension N_{RL}, and a value of the target dimension may be any integer less than a dimension of original data, that is, 832. For example, the value of the target dimension may be any one of 256, 128, 100, or 50. It may be understood that the target dimension is a dimension of the second data set.

Example 2: For a channel prediction scenario, the first device may predict channel information at a future moment by using a previous (or historical) measurement reference signal, where the measurement reference signal may be a periodic reference signal. The first data set may be a previous measurement reference signal. For example, it is assumed that a network device performs transmission by using a dual-polarized antenna array with four rows and eight columns, and performs reception by using two dual-polarized antennas, that is, the network device includes 64 transmitting ports and four receiving ports. In this case, the first data set may be a channel slice data set, and each input sample (each piece of channel slice data) in the first data set may include 32256 complex numbers, that is, 126 latency taps×4 receiving antennas×64 transmitting antennas. In this embodiment of this application, the first model (for example, a representation learning model) may be used to reduce the dimension of the first data set to a target dimension N_{RL}, and a value of the target dimension may be any integer less than a dimension of original data, that is, 32256. For example, the value of the target dimension may be any one of 4096, 2000, 1024, 500, or 256. It may be understood that the target dimension is the dimension of the second data set.

After training of the second model is completed, the first model may be trained. With reference to FIG. 11, the following describes a training process of the first model by using an example in which the first model includes a codec model. As shown in FIG. 11, the first model may include an AI encoder and an AI decoder. In this embodiment of this application, the first model may be trained by using the second data set as an input of the first model and the first data set as an output of the first model. It should be noted that in this embodiment of this application, using the first data set as the output of the first model may be understood as: using the first data set as a training label of the first model.

The foregoing describes in detail the training process of the first model. With reference to FIG. 12, the following describes a reasoning process of the first model. It should be noted that, the reasoning process of the first model corresponds to some content of the training process of the first model. For a part that is not described in detail, refer to the foregoing descriptions.

Referring to FIG. 12, in step S1210, a first device generates second data according to first data.

The first device may be a device in a wireless communications system. The first device may be, for example, a terminal device, or may be a network device.

The first data is wireless communication data. In some embodiments, the first data may be data to be encoded. For example, the first data may be CSI data to be fed back.

The second data is low-dimensional representation data of the first data, that is, the second data has less dimensions than the first data. A manner in which the second data is generated is not specifically limited in embodiments of this application. As an example, the first device may process the first data by using a specific algorithm, to generate the second data. The specific algorithm may be referred to as feature engineering. The algorithm may be designed according to some experience and prior knowledge.

As another example, the first device may process the first data by using a second model, to generate the second data. While performing dimensionality reduction on data, the second model can still retain more useful information of the data, which facilitates subsequent data processing. The second model may include, for example, an encoder in a VAE model. The VAE model has a strong representation capability, that is, a small dimension (or vector) may be used to represent more information, and can include higher-layer feature information. Therefore, using the encoder in the VAE model may reduce dimensions of data to a greater extent, thereby reducing complexity of subsequent data processing.

In step S1220, the first device obtains, according to the second data and a first model used for wireless communication, a processing result of the first model.

The first model in this embodiment of this application may be any AI model in a wireless communications system. The first model may be, for example, a service model or a task model. A type of the first model is not specifically limited in embodiments of this application. For example, the first model may be a neural network model, or the first model may be a deep learning model. In some embodiments, the first model may include a codec model, that is, the first model may include an AI encoder and an AI decoder. For example, the first model may include a CSI feedback model. Certainly, in some embodiments, the first model may include an encoding model, that is, the first model includes an AI encoder. Alternatively, the first model may include a decoding model, that is, the first model includes an AI decoder.

The first device may use the second data as an input of the first model, to obtain the processing result of the first model. The processing result of the first model may be understood as an output result of the first model. Because the second data has less dimensions than the first data, using the second data as the input of the first model may reduce a processing time of the first model and improve a processing speed of the first model.

For example, the first model includes a codec model, and the first model may include an AI encoder and an AI decoder. Since the AI encoder has a correspondence with the AI decoder, that is, the AI decoder can decode data encoded by the AI encoder, the AI encoder and the AI decoder need to undergo joint training together. After the training on the AI encoder and the AI decoder is completed, the AI encoder and/or the AI decoder need to be transmitted to a corresponding device. For example, if the AI encoder and the AI decoder are trained at an encoding end, the encoding end may transmit the AI decoder to a decoding end. If the AI encoder and the AI decoder are trained by the decoding end, the decoding end may transmit the AI encoder to the encoding end. If the AI encoder and the AI decoder are trained by a third-party device, the third-party device may transmit the AI encoder to the encoding end and transmit the AI decoder to the decoding end. The encoding end may also be referred to as a transmitting end, and the decoding end may also be referred to as a receiving end.

The following describes the solutions in embodiments of this application from a perspective of communication interaction by using an example in which a terminal device is an encoding end and a network device is a decoding end. A communication interaction process between the terminal device and the network device may include a model transmission process, or may include a model reasoning process. For details that are not described in detail in the following, refer to the foregoing descriptions.

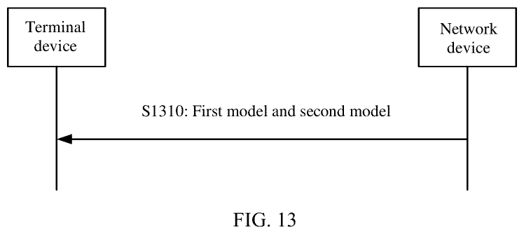

Referring to FIG. 13, in step S1310, the network device transmits a first model and a second model to the terminal device.

The first model in this embodiment of this application may be any first model in a wireless communications system. The first model may be, for example, a service model or a task model. A type of the first model is not specifically limited in embodiments of this application. For example, the first model may be a neural network model, or the first model may be a deep learning model. In some embodiments, the first model may include a codec model, that is, the first model may include an AI encoder and an AI decoder. For example, the first model may include a CSI feedback model. Certainly, in some embodiments, the first model may include an encoding model, that is, the first model includes an AI encoder. Alternatively, the first model may include a decoding model, that is, the first model includes an AI decoder.

The network device in this embodiment of this application may train the first model and the second model. Because the terminal device has limited memory space and a limited computing capability, the first model in this embodiment of this application may be trained by the network device, to reduce computing overheads of the terminal device. After completing the training, the network device may transmit the first model and the second model to the terminal device, so that the first model and the second model are deployed on the terminal device. The first model and the second model may be obtained by offline training model.

For a training process of the first model and the second model, refer to the foregoing descriptions. The second model may be used to convert first data of the terminal device into second data, where the second data is low-dimensional representation data of the first data. The first model may be used to process the second data. After obtaining the first model, the terminal device may perform reasoning on the first model by using the second data, or may perform training on the first model by using the second data.

In some embodiments, after obtaining the first model and the second model, the terminal device may process the first data by using the second model, to generate the second data. The terminal device may further process the second data by using the first model, to obtain a processing result of the first model. The first data may be data generated by the terminal device, or the first data may be data obtained by the terminal device through measurement, or the first data may be to-be-transmitted data of the terminal device. For example, the first model includes an AI encoder, and the processing result of the first model is encoded data. The terminal device may transmit the encoded data to the network device. After receiving the encoded data transmitted by the terminal device, the network device may process the encoded data by using an AI decoder, to generate the first data.

After the first model is deployed, the terminal device or the network device may further update (that is, train) the first model. The updating of the first model may be executed by the network device, or may be executed by the terminal device. The updating of the first model may be offline updating, or may be online updating. If the updating is offline updating, the updating of the first model may be executed by the network device, to reduce computing overheads of the terminal device.

In some embodiments, the terminal device may train the first model. For example, the terminal device may process the first data by using the second model, to generate the second data. The terminal device may train the first model by using the second data. A process of the training may be online training, that is, the terminal device may perform online training on the first model by using the second data.

In some embodiments, the network device may train the first model. For example, the network device may process the first data by using the second model, to generate the second data. The network device may perform updating and training on the first model by using the second data. After completing the training, the network device may transmit the updated first model to the terminal device.

For example, the first model includes an AI encoder and an AI decoder. The updating of the first model may include updating the AI encoder and the AI decoder at the same time, or may include updating only the AI encoder but not updating the AI decoder, or may include updating only the AI decoder but not updating the AI encoder.

Because the second model is not sensitive to data distribution, only the first model may be updated in this embodiment of this application. For example, the network device updates the first model. After updating the first model, the network device may transmit the updated first model to the terminal device. Because the first model is relatively small, updating efficiency of the first model is also improved. In addition, the relatively small first model also reduces resource overheads required for model transmission so that air interface overheads may be reduced.

The updating of the first model may include offline updating and online updating (or referred to as online training). As described above, the offline updating of the first model may be executed by the network device, to reduce the computing overheads of the terminal device. In some embodiments, the online training of the first model may also be executed by the network device, to further reduce the computing overheads of the terminal device. In some other embodiments, the online training of the first model may also be executed by the terminal device. Because the terminal device is a source party of data, performing the online training on the first model by the terminal device is more efficient.

The following separately describes an online training process performed by the network device and an online training process performed by the terminal device by using an example in which the first model includes an AI encoder and an AI decoder.

When the network device performs online training, the network device may obtain the first data from the terminal device. As an example, the terminal device may transmit the first data to the network device. For example, the terminal device may process the first data by using the second model, to generate the second data, and process the second data by using the AI encoder, to obtain encoded data. The terminal device transmits the encoded data to the network device. After receiving the encoded data, the network device decodes the encoded data by using the AI decoder, to obtain the first data. As another example, the wireless communications system in this embodiment of this application may further include a data collection module. The data collection module may collect the first data from the terminal device, and transmit the first data to the network device.

After obtaining the first data, the network device may process the first data by using the second model, to generate the second data. Further, the network device may update the first model (for example, the AI encoder) by using the second data, to obtain the updated first model. For example, the network device may perform online training on the first mode by using the second data as an input of the first model and the first data as an output of the first model. After the online training is completed, the network device may transmit the updated AI encoder to the terminal device. After receiving the updated AI encoder, the terminal device may process data by using the updated AI encoder. It should be noted that using the first data as the output of the first model may be understood as: using the first data as label data of the first model, that is, training the first model by using a difference between an output result of the first model and the first data.

In some embodiments, to reduce model transmission overheads, when training the first model, the network device may fix parameters in the AI encoder and update only parameters in the AI decoder. In this way, after updating the first model, the network device may not need to transmit the AI encoder to the terminal device, and the terminal device may still process data by using the previous AI encoder. After receiving encoded data transmitted by the terminal device, the network device may decode the encoded data by using the updated AI decoder. The encoded data may be the bit stream described above.

If the terminal device performs online training, the terminal device needs to obtain the AI decoder because the AI encoder and the AI decoder need to undergo joint training. In some embodiments, the network device may transmit the AI decoder in the first model to the terminal device, so that the terminal device can train the first model.

In a process of performing the online training, the terminal device may process the first data by using the second model, to generate the second data. Then, the terminal device may perform the online training on the first model (that is, the AI encoder and the AI decoder) by using the second data. After the online training is completed, the terminal device may transmit the updated AI decoder to the network device, so that the network device processes data by using the updated AI decoder.

In some embodiments, to reduce model transmission overheads of the terminal device, when training the first model, the terminal device may fix parameters of the AI decoder, and update only parameters of the AI encoder. In this way, after updating the first model, the terminal device may not need to transmit the AI decoder to the network device. In a data transmission process, the terminal device may encode data by using the updated AI encoder, and transmit the encoded data to the network device. The network device may decode the encoded data by using the original AI decoder, to restore the first data. The parameters of the AI decoder may be the same as or different from parameters of an AI decoder corresponding to another terminal device. This is not specifically limited in embodiments of this application.

An execution time of online training is not specifically limited in embodiments of this application. As an example, online training may be executed when new data is generated. As another example, online training may be executed when a quantity of samples reaches a preset threshold. The preset threshold may be set according to an actual requirement. For example, the preset threshold may be one or more of the following: 16, 32, 64, 128, or 512. As still another example, online training may be executed at a fixed interval, that is, online training may be periodically executed. The fixed interval may be set according to an actual requirement. For example, the fixed interval may be one or more of the following: 5 slots, 10 slots, 20 slots, or the like.

In some embodiments, the network device generally communicates with a plurality of terminal devices. An AI encoder of each terminal device corresponds to a respective AI decoder. If the network device stores a respective AI decoder for each terminal device, that is, the network device stores the AI decoders respectively corresponding to all the terminal devices, storage overheads and model management pressure of the network device are greatly increased. Therefore, AI encoders of different terminal devices in this embodiment of this application may correspond to a same AI decoder, that is, AI decoders respectively corresponding to AI encoders of a plurality of terminal devices have the same parameters. In this case, the network device may store only one AI decoder, and may decode encoded data transmitted by the plurality of terminal devices, to restore original data. This reduces the storage overheads and the model management pressure of the network device.

The solution in which AI decoders corresponding to AI encoders of a plurality of terminal devices have the same parameters may be combined with other solutions described above. For example, when performing training (online training or offline updating) on the first model, the network device may fix the parameters of the AI decoder in the first model, and train only the parameters in the AI encoder. After completing the training, the network device transmits the AI encoder to the terminal device. For another example, the terminal device may fix the parameters of the AI decoder, and train only the parameters of the AI encoder. The parameters of the AI decoder may be the same as parameters of an AI decoder corresponding to another terminal device. Certainly, the parameters of the AI decoder may also be different from the parameters of the AI decoder corresponding to the another terminal device. This is not specifically limited in embodiments of this application.

The foregoing describes the model training process, and the following describes the model reasoning process.

For the model reasoning process, the terminal device may process the first data by using the second model, to generate the second data. Then, the terminal device may process the second data by using the AI encoder, to generate encoded data. The terminal device may transmit the encoded data to the network device. After receiving the encoded data, the network device may process the encoded data by using the AI decoder, to generate the first data. It should be noted that the AI decoder only restores the first data as much as possible, and an output of the AI decoder is not necessarily the same as the first data. That is, the first data generated by the network device may be different from the first data on the terminal device side.

The online training process and the data reasoning process in this embodiment of this application may be performed at the same time. For example, the terminal device may not only process the second data by using the AI encoder, to generate the encoded data, but also train the AI encoder by using the second data, to update the first model.

With reference to three embodiments, the following describes the solutions in embodiments of this application in detail by using an example in which the first model includes a CSI feedback model, and the second model includes a representation learning model. It should be noted that the following embodiments are merely examples for ease of understanding and description of the solutions in embodiments of this application, and are not intended to limit embodiments of this application. Embodiment 1 describes an offline training and updating process of a CSI feedback model. Embodiment 2 and Embodiment 3 describe an online training process of a CSI feedback model. A difference between Embodiment 2 and Embodiment 3 lies in that the network device performs online training on the CSI feedback model in Embodiment 2, while the terminal device performs online training on the CSI feedback model in Embodiment 3. The following describes Embodiment 1 to Embodiment 3.

### Embodiment 1

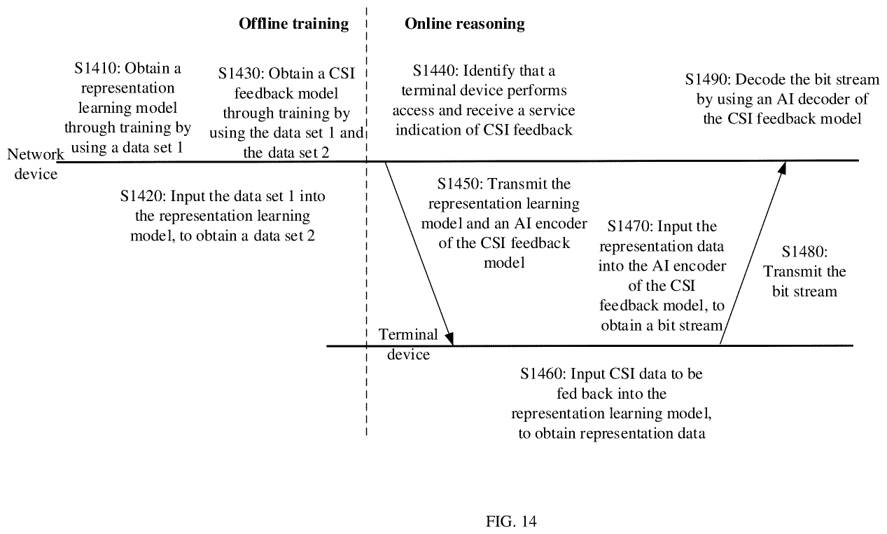

Referring to FIG. 14, in step S1410, a network device may train a representation learning model by using a data set 1. The representation learning model may be the second model described above. The representation learning model may include, for example, an encoder in a VAE model.

In step S1420, after completing the training of the representation learning model, the network device inputs data in the data set 1 into the trained representation learning model, and may reason out low-dimensional representation data of each piece of data, to obtain a data set 2. The data set 2 may be understood as a low-dimensional representation data set of the data set 1. Compared with the data in the data set 1, data in the data set 2 has a greatly reduced dimension.

In step S1430, the network device may obtain a CSI feedback model through training by using the data set 1 and the data set 2. The CSI feedback model may be the first model described above. The network device uses the data in the data set 2 as an input and the data in the data set 1 as an output to obtain the CSI feedback model through training. The CSI feedback model includes an AI encoder and an AI decoder. However, the AI encoder in the CSI feedback model does not directly encode CSI data to be fed back into encoded data, but encodes low-dimensional representation data of the CSI data to be fed back. Since the data set 2 is a low-dimensional representation of the data set 1, the AI encoder of the CSI feedback model is a lightweight model.

In step S1440, the network device detects that a terminal device accesses the network device and the network device receives first indication information, where the first indication information is used to instruct the network device to transmit a model to the terminal device. The first indication information may be, for example, a service indication that triggers CSI feedback.

In step S1450, the network device transmits the representation learning model and the AI encoder of the CSI feedback model to the terminal device, so that the terminal device processes data by using the representation learning model and the AI encoder of the CSI feedback model. Because the representation learning model is not sensitive to data, the representation learning model does not need to be updated after being deployed, and a subsequent updating policy relates only to updating of the CSI feedback model.

In a model updating process, the network device may input a new data set 3 into the representation learning model, to obtain a data set 4. The network device updates the CSI feedback model by using the data set 3 and the data set 4, to obtain the updated CSI feedback model. The network device transmits the AI encoder of the updated CSI feedback model to the terminal device. After each time of updating, the network device transmits only an AI encoder of a CSI feedback model with a smaller quantity of parameters to the terminal device, and no longer transmits the representation learning model. Compared with a conventional solution, in an updating process, model transmission overheads between the network device and the terminal device can be reduced.

After training or updating ends, the terminal device and the network device may execute a reasoning process to jointly complete a CSI feedback task.

In step S1460, the terminal device measures a channel to obtain CSI data to be fed back. The terminal device inputs the CSI data to be fed back into the representation learning model, to obtain low-dimensional representation data of the CSI data to be fed back.

In step S1470, the terminal device inputs the low-dimensional representation data into the AI encoder of the CSI feedback model for reasoning, to obtain encoded data.

In step S1480, the terminal device transmits the encoded data to the network device by using an air interface resource.

In step S1490, the network device performs reasoning on the encoded data by using the AI decoder of the CSI feedback model, to obtain the original CSI data through decoding.

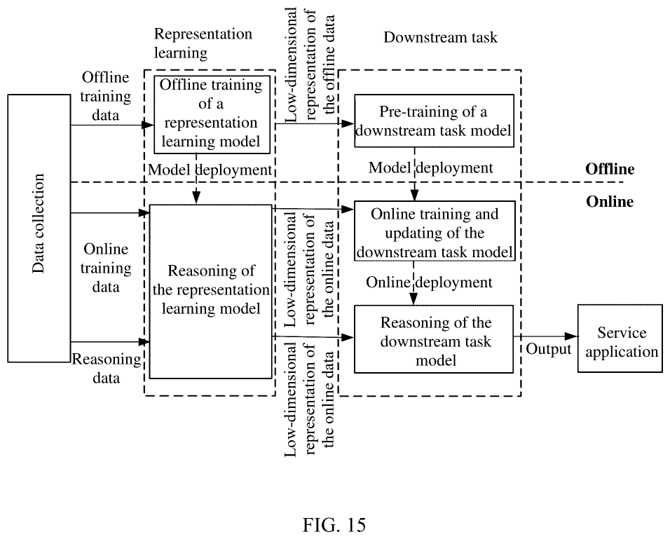

Before Embodiment 2 and Embodiment 3 are described, an online training procedure that can be used in Embodiment 2 and Embodiment 3 is first described by using FIG. 15 as an example.

Referring to FIG. 15, an entire flowchart in this embodiment of this application may be divided into three main working modules from left to right: a data collection module, a representation learning module, and a downstream task module. Compared with the online learning solution shown in FIG. 6, in this embodiment of this application, the representation learning module is added between the downstream task module and the data collection module. The representation learning model may process high-dimensional original data into low-dimensional data, that is, may express the high-dimensional data by using a smaller amount of information. Compared with a conventional solution, the downstream task model in this embodiment of this application is significantly reduced, thereby implementing model compression. For online learning, an amount of computation in each iteration can be reduced, thereby effectively resolving the problem of timeliness of online training.

The data collection module may be a system data platform, configured to implement data pre-processing such as data filtering, and respectively provide training data and reasoning data in a model training phase and a reasoning phase.

The representation learning module may include any type of second model described above, or may be a representation learning algorithm based on a specific algorithm. A representation learning model is used as an example. An input of the representation learning model is high-dimensional original data, and an output is a low-dimensional representation of the original data. A manner of training the representation learning model may be determined with reference to the representation learning algorithm. This is not specifically limited in embodiments of this application. A representation learning model based on a VAE model is used as an example. An input and an output of the VAE model are both original data. A loss function of a VAE standard (reconstruction loss and distribution assumption loss) may be used to obtain the VAE model through training. A decoder of the VAE model is deleted, and an obtained encoder is an ideal representation learning model. An input of the encoder is original data, and an output is a low-dimensional representation of the original data. The trained representation learning model may be deployed on an online device. The representation learning model is not sensitive to a data distribution change. Therefore, online training and updating are no longer performed on the representation learning model after the model is deployed.

Reasoning of the representation learning model may be executed after the model is deployed. During the model reasoning, high-dimensional reasoning data may be input into the representation learning model, to obtain a low-dimensional representation of the high-dimensional original data through reasoning.

The downstream task model may be, for example, the AI model described above, for example, the CSI feedback model. In offline pre-training of the downstream task model, a target function and a model structure may be designed according to a service requirement, and the pre-training of the model may be completed offline by using low-dimensional representation data obtained by reasoning of the representation learning module. After the training is completed, the downstream task model may be deployed on an online device.

In online training of the downstream task model, new data may be continuously used to complete the online training of the downstream task model on the basis of the offline training, to obtain a model that better complies with current data distribution. An online data set used for the online training may be a low-dimensional representation data set obtained by reasoning of the representation learning module.

Reasoning of the downstream task model may refer to inputting reasoning data into the trained model to obtain an expected output of the model. The reasoning data may be low-dimensional representation data obtained by the representation learning module performing reasoning on online reasoning data.

### Embodiment 2

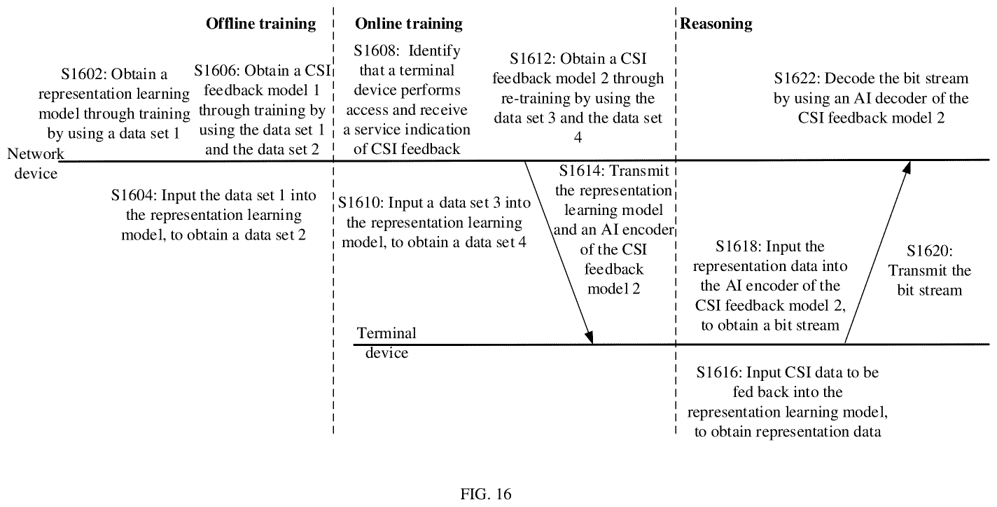

Referring to FIG. 16, in step S1602, a network device trains a representation learning model by using a data set 1 (that is, an offline data set). The representation learning model may be the second model described above. The representation learning model may include, for example, an encoder in a VAE model.

In step S1604, after completing the training of the representation learning model, the network device inputs data in the data set 1 into the trained representation learning model, and may reason out low-dimensional representation data of each piece of data, to obtain a data set 2. The data set 2 may be understood as a low-dimensional representation data set of the data set 1. Compared with the data in the data set 1, data in the data set 2 has a greatly reduced dimension.

In step S1606, the network device may obtain a CSI feedback model 1 through training by using the data set 1 and the data set 2. The CSI feedback model 1 may be the AI model described above. The network device uses the data in the data set 2 as an input and the data in the data set 1 as an output to obtain the CSI feedback model 1 through training. The CSI feedback model 1 includes an AI encoder and an AI decoder. However, the AI encoder in the CSI feedback model 1 does not directly encode CSI data to be fed back into encoded data, but encodes low-dimensional representation data of the CSI data to be fed back. Since the data set 2 is a low-dimensional representation of the data set 1, the AI encoder of the CSI feedback model 1 is a lightweight model.

After the offline training is completed, the network device may perform online training.

In step S1608, if the network device detects that a terminal device accesses the network device and the network device receives second indication information, the network device may perform online training on the CSI feedback model. The second indication information is used to instruct the network device to perform online training on the CSI feedback model. The second indication information may be, for example, a service indication that triggers CSI feedback. In some embodiments, the network device may perform online training on the CSI feedback model after preparatory work of online data and the like is completed.

In step S1610, the network device inputs a data set 3 (also referred to as an online data set) into the representation learning model, so as to reason out low-dimensional representation data of each piece of data in the data set 3, to obtain a data set 4. Compared with the data in the data set 3, data in the data set 4 has a greatly reduced dimension.

In step S1612, similar to step S1606, the network device may update the CSI feedback model 1 by using the data set 4 as an input and the data set 3 as an output, to obtain a CSI feedback model 2. In a process of updating the CSI feedback model, the structure of the CSI feedback model is not adjusted again, and only parameters of the model are updated. Therefore, a model structure size of the CSI feedback model 1 is consistent with that of the CSI feedback model 2, and a difference between the two models only lies in different parameters of the models. In addition, because an AI encoder of the CSI feedback model 2 encodes low-dimensional representation data of CSI data, the AI encoder of the CSI feedback model is also a lightweight network model.

When updating the CSI feedback model, the network device may continuously update the model as real-time data continuously arrives. In this embodiment of this application, the data collection model may continuously transmit CSI data to the network device, and the CSI data is directly converted into low-dimensional data by step S1610. When a quantity of samples in the online data set 4 meets a preset quantity (for example, 16, 32, 64, or 128) or a waiting time meets a preset waiting time (for example, 5 slots, 10 slots, or 20 slots), the network device is triggered to execute step S1612 again, to complete updating of the CSI feedback model.

In step S1614, the network device may transmit the representation learning model and the AI encoder of the CSI feedback model 2 to the terminal device by using an air interface resource, so that the terminal device completes deployment of the model.

After completing the deployment of the model, the terminal device may start to execute reasoning of the model. The terminal device and the network device may jointly complete a CSI feedback task.

In step S1616, the terminal device performs channel measurement to obtain CSI data to be fed back. The terminal device inputs the CSI data to be fed back into the representation learning model, to obtain low-dimensional representation data of the CSI data to be fed back.

In step S1618, the terminal device performs reasoning on the low-dimensional representation data by using the AI encoder of the CSI feedback model 2, to obtain encoded data.

In step S1620, the terminal device reports the encoded data to the network device by using an air interface resource.

In step S1622, the network device obtains an AI decoder corresponding to the terminal device, that is, an AI decoder of the CSI feedback model 2. The network device performs reasoning on the encoded data by using the AI decoder of the CSI feedback model 2, to obtain the original CSI data through decoding.

It should be noted that the foregoing online training process and the foregoing reasoning process of the CSI feedback model may be performed at the same time. The network device may perform reasoning on the CSI feedback model by using CSI data, or may update the CSI feedback model by using CSI data. When performing reasoning, the network device may always use a latest CSI feedback model for reasoning.

### Embodiment 3

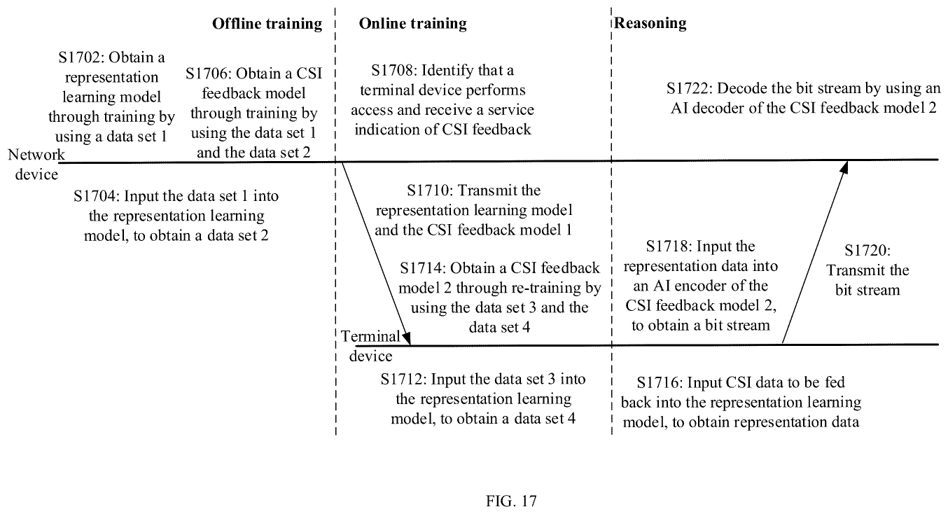

Referring to FIG. 17, in step S1702, a network device trains a representation learning model by using a data set 1 (that is, an offline data set). The representation learning model may be the second model described above. The representation learning model may include, for example, an encoder in a VAE model.

In step S1704, after completing the training of the representation learning model, the network device inputs data in the data set 1 into the trained representation learning model, and may reason out low-dimensional representation data of each piece of data, to obtain a data set 2. The data set 2 may be understood as a low-dimensional representation data set of the data set 1. Compared with the data in the data set 1, data in the data set 2 has a greatly reduced dimension.

In step S1706, the network device may obtain a CSI feedback model 1 through training by using the data set 1 and the data set 2. The CSI feedback model 1 may be the AI model described above. The network device uses the data in the data set 2 as an input and the data in the data set 1 as an output to obtain the CSI feedback model 1 through training. The CSI feedback model 1 includes an AI encoder and an AI decoder. However, the AI encoder in the CSI feedback model 1 does not directly encode CSI data to be fed back into encoded data, but encodes low-dimensional representation data of the CSI data to be fed back. Since the data set 2 is a low-dimensional representation of the data set 1, the AI encoder of the CSI feedback model 1 is a lightweight model.

After the offline training is completed, online training is performed.

In step S1708, the network device identifies that a terminal device accesses the network device and the network device receives third indication information, where the third indication information is used to instruct to perform online training on the CSI feedback model, or the third indication information is used to instruct the network device to transmit the representation learning model or the CSI feedback model to the terminal device. The third indication information may be, for example, a service indication that triggers CSI feedback.

In step S1710, the network device transmits the representation learning model and the AI encoder of the CSI feedback model 1 to the terminal device. The terminal device may collect online data to obtain an online data set 3. The online data set 3 may include a single sample, or may include a batch of samples.

In step S1712, the terminal device inputs the data set 3 into the representation learning model, and may obtain low-dimensional representation data of data in the data set 3 through reasoning, to obtain a data set 4. Compared with the data in the data set 3, data in the data set 4 has a greatly reduced dimension.

In step S1714, similar to step S1706, the terminal device may update the CSI feedback model 1 by using the data set 4 as an input and the data set 3 as an output, to obtain a CSI feedback model 2. In a process of updating the CSI feedback model, the structure of the CSI feedback model is not adjusted again, and only parameters of the model are updated. Therefore, a model structure size of the CSI feedback model 1 is consistent with that of the CSI feedback model 2, and a difference between the two models only lies in different parameters of the models. In addition, because an AI encoder part of the CSI feedback model 2 encodes low-dimensional representation data of CSI data, the AI encoder of the CSI feedback model 2 is also a lightweight network model.

To reduce air interface overheads, in a process of updating and training the CSI feedback model 1, the terminal device may fix parameters of the decoder in the CSI feedback model 1. That is, in the online training process, only parameters of the AI encoder are updated, and no parameter of the AI decoder is updated. In this way, after completing the online training of the CSI feedback model, the terminal device does not need to transmit an updated AI decoder to the terminal device, so that air interface overheads is reduced. That is, the parameters of the AI decoder in the CSI feedback model 1 are the same as parameters of the AI decoder in the CSI feedback model 2.

In addition, the AI decoder in the CSI feedback model may be adapted to AI encoders in a plurality of terminal devices, that is, AI encoders in different terminal devices may correspond to a same AI decoder. In this case, the network device may store a relatively small quantity of AI decoders. For example, the network device may store only one AI decoder, and the AI decoder may be configured to decode encoded data transmitted by a plurality of terminal devices.

In the case of online learning, the terminal device continuously generates CSI data as long as the terminal device is in an online status. The terminal device may convert the newly generated data into low-dimensional representation data by step S1712. When a quantity of samples in the online data set 4 meets a preset quantity (for example, 16, 32, 64, or 128) or a waiting time meets a preset waiting time (for example, 5 slots, 10 slots, or 20 slots), the terminal device is triggered to execute step S1714 again, to complete updating of the CSI feedback model.

After the training and updating of the model are completed, reasoning of the model may start to be executed. The terminal device and the network device may jointly complete a CSI feedback task.

In step S1716, the terminal device performs channel measurement to obtain CSI data to be fed back. The terminal device inputs the CSI data to be fed back into the representation learning model, to obtain low-dimensional representation data of the CSI data to be fed back.

In step S1718, the terminal device performs reasoning on the low-dimensional representation data by using the AI encoder of the CSI feedback model 2, to obtain encoded data.

In step S1720, the terminal device reports the encoded data to the network device by using an air interface resource.

In step S1722, the network device obtains an AI decoder corresponding to the terminal device, that is, an AI decoder of the CSI feedback model 2. The network device performs reasoning on the encoded data by using the AI decoder of the CSI feedback model 2, to obtain the original CSI data through decoding.

It should be noted that the foregoing online training process and the foregoing reasoning process of the CSI feedback model may be performed at the same time. The terminal device may perform reasoning on the CSI feedback model by using CSI data to be fed back, or may update the CSI feedback model by using CSI data to be fed back. When performing reasoning, the terminal device may always use a latest CSI feedback model for reasoning.

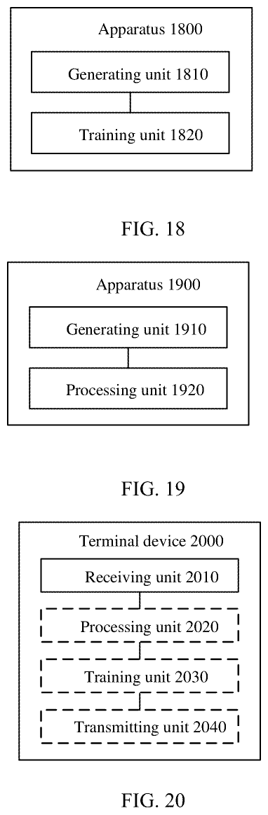

The foregoing describes method embodiments of this application in detail with reference to FIG. 1 to FIG. 17. The following describes apparatus embodiments of this application in detail with reference to FIG. 18 to FIG. 22. It should be understood that the descriptions of the method embodiments correspond to the descriptions of the apparatus embodiments, and therefore, for parts that are not described in detail, refer to the foregoing method embodiments.

FIG. 18 is a schematic structural diagram of a training apparatus according to an embodiment of this application. The training apparatus 1800 shown in FIG. 18 may be any type of first device described above. The training apparatus 1800 may include a generating unit 1810 and a training unit 1820.

The generating unit 1810 is configured to generate a second data set according to a first data set, where data in the second data set is low-dimensional representation data of data in the first data set.

The training unit 1820 is configured to train, according to the second data set, a first model used for wireless communication.

In some embodiments, the generating unit 1810 is configured to train a second model according to the first data set; and process the first data set by using the second model, to generate the second data set.

In some embodiments, the second model includes an encoder in a VAE model.

In some embodiments, the training unit 1820 is configured to use the second data set as an input of the first model, to obtain an output result of the first model; and train the first model by using a difference between an output result of the first model and label data of the first model.

In some embodiments, the first model includes a codec model, and label data for the first model is the data in the first data set.

In some embodiments, the first model includes a CSI feedback model.

FIG. 19 is a schematic structural diagram of an apparatus for using a model according to an embodiment of this application. The apparatus 1900 for using a model shown in FIG. 19 may be any type of first device described above. The apparatus 1900 may include a generating unit 1910 and a processing unit 1920.

The generating unit 1910 is configured to generate second data according to first data, where the second data is low-dimensional representation data of the first data.

The processing unit 1920 is configured to obtain, according to the second data and a first model used for wireless communication, a processing result of the first model.

In some embodiments, the generating unit 1910 is configured to process the first data by using a second model, to generate the second data.

In some embodiments, the second model includes an encoder in a VAE model.

In some embodiments, the first model includes a CSI feedback model.

FIG. 20 is a schematic structural diagram of a terminal device according to an embodiment of this application. The terminal device 2000 shown in FIG. 20 may be any type of terminal device described above. The terminal device 2000 may include a receiving unit 2010.

The receiving unit 2010 is configured to receive a first model and a second model from a network device, where the second model is used to convert first data of the terminal device into second data, the second data has less dimensions than the first data, and the first model is used to process the second data.

In some embodiments, the receiving unit 2010 is further configured to receive an AI decoder in the first model from the network device; and the terminal device 2000 further includes a processing unit 2020, configured to process the first data by using the second model, to generate the second data; and a training unit 2030, configured to train the first model by using the second data.

In some embodiments, the first model includes an AI encoder and an AI decoder, and the training unit 2030 is configured to train the AI encoder by using the second data while fixing parameters of the AI decoder.

In some embodiments, the receiving unit 2010 is further configured to receive an updated first model from the network device, where the updated first model is obtained by training the AI encoder by using the second data.

In some embodiments, the terminal device 2000 further includes a processing unit 2020, configured to process the first data by using the second model, to generate the second data. The processing unit 2020 is further configured to process the second data by using the first model, to obtain a processing result of the first model.

In some embodiments, the first model includes an AI encoder, the processing result of the first model is encoded data, and the terminal device 2000 further includes a transmitting unit 2040, configured to transmit the encoded data to the network device.

In some embodiments, the second model includes an encoder in a VAE model.

In some embodiments, the first model includes a CSI feedback model.

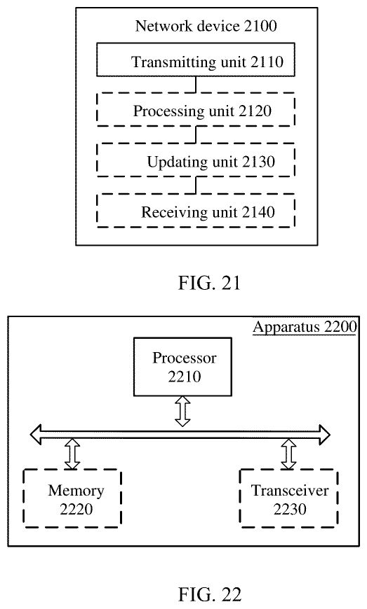

FIG. 21 is a schematic structural diagram of a network device according to an embodiment of this application. The network device 2100 shown in FIG. 21 may be any type of network device described above. The network device 2100 may include a transmitting unit 2110.

The transmitting unit 2110 is configured to transmit a first model and a second model to a terminal device, where the second model is used to convert first data of the terminal device into second data, the second data has less dimensions than the first data, and the first model is used to process the second data.

In some embodiments, the network device 2100 further includes a processing unit 2120, configured to process the first data by using the second model, to generate the second data; and an updating unit 2130, configured to update the first model by using the second data, to obtain an updated first model. The transmitting unit 2110 is further configured to transmit the updated first model to the terminal device.

In some embodiments, the first model includes an AI encoder, and the network device 2100 further includes a receiving unit 2140, configured to receive encoded data from the terminal device, where the encoded data is obtained by the AI encoder by processing the second data; and a processing unit 2120, configured to process the encoded data by using the AI decoder, to generate the first data.

In some embodiments, the second model includes an encoder in a VAE model.

In some embodiments, the first model includes a CSI feedback model.

FIG. 22 is a schematic structural diagram of an apparatus according to an embodiment of this application. The dashed lines in FIG. 22 indicate that the unit or module is optional. The apparatus 2200 may be configured to implement the methods described in the foregoing method embodiments. The apparatus 2200 may be a chip, a first device, a terminal device, or a network device.

The apparatus 2200 may include one or more processors 2210. The processor 2210 may allow the apparatus 2200 to implement the method described in the foregoing method embodiments. The processor 2210 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 2200 may further include one or more memories 2220. The memory 2220 stores a program, where the program may be executed by the processor 2210, to cause the processor 2210 to execute the methods described in the foregoing method embodiments. The memory 2220 may be independent of the processor 2210 or may be integrated into the processor 2210.

The apparatus 2200 may further include a transceiver 2230. The processor 2210 may communicate with another device or chip by using the transceiver 2230. For example, the processor 2210 may transmit data to and receive data from another device or chip by using the transceiver 2230.

An embodiment of this application further provides a computer-readable storage medium, configured to store a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods executed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B corresponding to A” means that B is associated with A, and B may be determined based on A. However, it should also be understood that, determining B based on A does not mean determining B only based on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “pre-defining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined based on functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections via some interfaces, apparatuses or units, and may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A training device, comprising a processor configured to perform operations of:
generating a second data set according to a first data set, wherein data in the second data set is low-dimensional representation data of data in the first data set; and
training, according to the second data set, a first model used for wireless communication.

2. The training device according to claim 1, wherein the processor is configured to perform operations of:
training a second model according to the first data set; and
processing the first data set by using the second model, to generate the second data set.

3. The training device according to claim 2, wherein the second model comprises an encoder in a variational auto-encoder (VAE) model.

4. The training device according to claim 1, wherein the processor is configured to perform operations of comprises:
using the second data set as an input of the first model, to obtain an output result of the first model; and
training the first model by using a difference between an output result of the first model and label data of the first model.

5. The training device according to claim 1, wherein the first model comprises a codec model, and label data for the first model is the data in the first data set.

6. The training device according to claim 1, wherein the first model comprises a channel state information (CSI) feedback model.

7. The training device according to claim 2, wherein the training device is a network device, and the processor is configured to perform an operation of:
transmitting the first model and the second model to a terminal device.

8. The training device according to claim 7, wherein the processor is configured to perform operations of:
receiving first data from the terminal device;
processing the first data by using the second model, to generate the second data, wherein the second data has less dimensions than the first data;
updating the first model by using the second data, to obtain an updated first model; and
transmitting the updated first model to the terminal device.

9. A device for using a model, comprising a processor configured to perform operations of:
generating second data according to first data, wherein the second data is low-dimensional representation data of the first data; and
obtaining, according to the second data and a first model used for wireless communication, a processing result of the first model.

10. The device according to claim 9, wherein the processor is configured to perform operations of:
processing, the first data by using a second model, to generate the second data.

11. The device according to claim 10, wherein the second model comprises an encoder in a variational auto-encoder (VAE) model.

12. The device according to claim 9, wherein the first model comprises a channel state information (CSI) feedback model.

13. A terminal device, comprising a processor configured to perform an operation of:
receiving a first model and a second model from a network device,
wherein the second model is used to convert first data acquired by the terminal device into second data, the second data has less dimensions than the first data, and the first model is used to process the second data.

14. The terminal device according to claim 13, wherein the processor is configured to perform operations of:
processing the first data by using the second model, to generate the second data; and
training the first model by using the second data.

15. The terminal device according to claim 14, wherein the first model comprises an AI encoder and an AI decoder, and the processor is configured to perform an operation of:
training the AI encoder by using the second data while fixing parameters of the AI decoder.

16. The terminal device according to claim 13, wherein the processor is configured to perform an operation of:
receiving an updated first model from the network device, wherein the updated first model is obtained by training the first model by using the second data.

17. The terminal device according to claim 13, wherein the processor is configured to perform operations of:
processing the first data by using the second model, to generate the second data; and
processing the second data by using the first model, to obtain a processing result of the first model.

18. The terminal device according to claim 17, wherein the first model comprises an AI encoder, the processing result of the first model is encoded data, and the processor is configured to perform an operation of:
transmitting the encoded data to the network device.

19. The terminal device according to claim 13, wherein the second model comprises an encoder in a variational auto-encoder (VAE) model.

20. The terminal device according to claim 13, wherein the first model comprises a channel state information (CST) feedback model.
